(19) United States
(12) Patent Application Publication
(10) Pub. No.: US 2006/0210315 A1
(43) Pub. Date: Sep. 21, 2006

(54) Image forming apparatus

(75) Inventors: Masahide Nakamura, Nagano (JP); Hidehiro Takano, Nagano (JP); Koichi Kamijo, Nagano (JP); Ken Ikuma, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/367,018

(22) Filed: Mar. 1, 2006

(30) Foreign Application Priority Data
Mar. 1, 2005 (JP) P2005-055689
Mar. 14, 2005 (JP) P2005-071168
Mar. 14, 2005 (JP) P2005-071169

(51) Int. Cl. G03G 15/10

(52) U.S. Cl. 399/237

(57) ABSTRACT

An image forming apparatus includes a developing section in which an image is developed by using liquid toner. The liquid toner has passed through the developing section is conveyed in a first path by gravity. A tank is adapted to store a carrier liquid, and is connected to a second path in which the carrier liquid stored in the tank is conveyed by gravity and which joins the first path.

### BACKGROUND OF THE INVENTION

The present invention relates to an image forming apparatus for developing an electrostatic latent image, formed on a photoreceptor, by employing a liquid toner prepared by dispersing toner particles in a carrier liquid.

Related image forming apparatuses are known that develop electrostatic latent images by employing liquid toner prepared by dispersing toner particles in a carrier liquid. Also known, for such image forming apparatuses, are arts for collecting and recycling the liquid toner.

One image forming apparatus that employs a liquid toner to develop an electrostatic latent image is disclosed in JP-A-10-282796. According to JP-A-10-282796, liquid toner that is not used during development is collected, and after having been separated into high-density liquid and into either carrier liquid or low-density liquid, is stored separately, in appropriate containers. Subsequently, these liquids are mixed together to obtain an adjusted, predetermined density, which will permit the liquid mixture to be reused. As a further refinement of this process, the collected carrier liquid is collected in a new carrier tank in which it is mixed with new carrier liquid, and this mixture of new and collected carrier liquid is then used for development.

According to JP-A-10-282796, in an apparatus in which a photoreceptor is coated by the application of a prewetting liquid and during the development process the prewetting liquid and the liquid toner are mixed, the density of the liquid toner collected thereafter is lowered. Consequently, after the liquid has been collected and separated into high-density liquid and into either carrier liquid or low-density liquid, part of the low-density liquid can be mixed, as needed, with the high-density liquid to obtain a mixture having an adjusted, predetermined density, and this liquid mixture can be reused. Therefore, during normal operation, since the amount of carrier liquid or low-density liquid constitutes a surplus, new carrier liquid is not regularly required and is employed only as an auxiliary supplement. That is, new carrier liquid is employed for fine adjustment of the density or viscosity of toner after the toner density has been adjusted, or is employed for a case in which toner in a development container is discarded after having been contaminated by dust that entered the container, and carrier liquid is mixed with new high-density toner to prepare liquid toner having a predetermined density.

For an apparatus that does not employ a prewetting liquid, since there is no reduction in the density of collected liquid toner due to prewetting liquid, the density of the collected liquid is not always reduced to less than a predetermined density. For example, when only solid white printing is performed and no toner particles are consumed, since only carrier liquid is consumed, the density of the collected liquid can easily exceed the predetermined density. In this case, new carrier liquid must be supplied in order for the density of the collected liquid to be adjusted and a predetermined density obtained. In addition to printing performed at such an extremely low printing density, even for normal printing performed at a printing density that is lower than the printing density limit defined in the setup for the apparatus, carrier liquid must be continuously supplied in order to finely adjust the toner density.

However, while collected carrier liquid contains a dispersant, new carrier liquid does not. This is because dispersant is separated from toner particles by the electric field applied at the development nip, and from the beginning, surplus floating dispersant is present in the carrier liquid. Assume that in a condition in which dispersant is present in collected carrier liquid, the collection of the carrier liquid is performed by the configuration in JP-A-10-282796 in which the collected carrier liquid is merely collected from above. Since in the initial state, dispersant is not present in the collected carrier liquid, pure carrier liquid is supplied to the development device for the adjustment of the density. However, as the operation of the apparatus continues, the density of the dispersant in the collected carrier liquid is increased. And as a result, as the density of the dispersant in the collected carrier liquid supplied to the development device is changed, the characteristic of the liquid toner, for which the density is controlled, fluctuates, and a uniform image quality can not be obtained.

In JP-A-10-282796, gravity enable to collect and supply liquid toner without using a pump or the like, and a valve controls a supply volume of the liquid toner.

However, when liquid toner having a thixotropy characteristic and low flowability and high viscosity is employed for a small apparatus in which a limitation is imposed on the diameters of conveying pipes and the layout of the pipes, in some cases, using a pump or a screw to convey this liquid can save substantially more space. On the other hand, since a carrier liquid is a Newtonian fluid having a satisfactory flowability, a low-density liquid for which the toner particle content is small can maintain an appropriate flowability even when the pipe used has a small diameter (an internal diameter of about 5 to 10 mm). Therefore, the downsizing and simplification of the apparatus are enabled by employing gravity, without a pump and a screw being required, and low viscosity liquid is collected by an extra carrier liquid removal member provided above a photoreceptor or an intermediate transfer member. However, when the operation of the apparatus was continued, the following problem was encountered. That is, toner particles contained in the low viscosity liquid accumulated in the bent portion of the pipe, or in a supply volume adjustment valve, until finally, clogging occurred. This is because the specific gravity of toner particles is greater than that of the carrier liquid and they tend to settle, so that their movement does not match the flow of the carrier liquid and they are gradually accumulated. Such clogging especially tends to occur when there is a limitation in the sizes of the pipes and valves provided for a small apparatus (a printer) intended for office use. Further, unlike regular printers, periodical maintenance is not performed for such small apparatuses, so that clogging can cause a failure.

### SUMMARY

It is therefore an object of the invention to provide an image forming apparatus having a simple configuration, in which a carrier liquid is supplied to a development device while the density of a dispersant contained in a carrier liquid stored in a tank is maintained, so that the characteristic of liquid toner is stabilized and a uniform image quality is obtained.

It is also an object of the invention to provide an image forming apparatus having a simple configuration that can prevent clogging of pipes and valves by toner particles, by employing a liquid toner and a carrier supply cartridge that can easily be detached.

In order to achieve the object, according to the invention, there is provided an image forming apparatus, including a developing section in which an image is developed by using liquid toner, the image forming apparatus comprising:

a first path, in which the liquid toner having passed through the developing section is conveyed by gravity;

a tank, adapted to store a carrier liquid, and connected to a second path in which the carrier liquid stored in the tank is conveyed by gravity and which joins the first path.

A valve may be arranged at a downstream side of a junction of the first path at which the second path joins the first path.

The image forming apparatus may have a plurality of the developing sections, a plurality of the first path may be provided with the developing sections, respectively, and a plurality of the tank may be provided with the developing sections, respectively.

The the image forming apparatus may have a plurality of the developing sections, the first path may be provided with the developing sections in common, and the tank may be provided with the developing sections in common.

The tank may include a replaceable cartridge.

A first backflow valve may be provided at a replaceable cartridge side of a junction at which the second path joins the first path, and a second backflow valve may be provided at a first path side of the junction.

In order to achieve the object, according to the invention, there is provided an image forming apparatus, including a developing section in which an image is developed by using liquid toner, the image forming apparatus comprising:

a first path, in which the liquid toner having passed through the developing section is conveyed by gravity;

a carrier liquid cartridge, adapted to store a carrier liquid, and provided with an inlet: which is detachably connected to the first path; and into which the liquid toner flows, and an outlet: from which the toner liquid and the carrier liquid flow out; and which is detachably connected to a second path in which the toner liquid and the carrier liquid are conveyed; and

a collector, located at an upstream side of the outlet in the carrier liquid cartridge, and operable to collect a toner particle.

A valve may be arranged at a downstream side of the outlet.

The collector may include a filter.

The collector may include a precipitation tank.

The collector may include an electrostatic precipitator.

The image forming apparatus may have a plurality of the developing sections, a plurality of the first path may be provided with the developing sections, respectively, and a plurality of the carrier liquid cartridge may be provided with the developing sections, respectively.

The image forming apparatus may have a plurality of the developing sections, the first path may be provided with the developing sections in common, and the carrier liquid cartridge may be provided with the developing sections in common.

In order to achieve the object, according to the invention, there is provided an image forming apparatus, including a developing section in which an image is developed by using liquid toner, the image forming apparatus comprising:

a first path, in which the liquid toner having passed through the developing section and collected at a collection section is conveyed by gravity;

a carrier liquid cartridge, adapted to store a carrier liquid, and connected to the first path;

an ultrasonic wave application unit, located at a connection part connecting the first path and the collection section, and operable to apply ultrasonic vibration to a toner particle.

The collection section may be one of either a photoreceptor squeeze roller, for collecting extra carrier liquid from a photoreceptor, an intermediate transfer member squeeze roller, for collecting extra carrier liquid from an intermediate transfer member, and a photoreceptor cleaner blade, or an assembly that includes all of these.

A valve may be located at a downstream side of an outlet of the carrier liquid cartridge from which the toner liquid and the carrier liquid flow out.

An ultrasonic wave application unit may be arranged between the outlet and the valve.

The image forming apparatus may have a plurality of the developing sections, a plurality of the first path may be provided with the developing sections, respectively, and a plurality of the carrier liquid cartridge may be provided with the developing sections, respectively.

The image forming apparatus may have a plurality of the developing sections, the first path may be provided with the developing sections in common, and the carrier liquid cartridge may be provided with the developing sections in common.

### BRIEF DESCRIPTION OF THE DRAWINGS

FIG. 1 is a diagram showing the general configuration of an image forming apparatus according to the first embodiment of the present invention.

FIG. 2 is a diagram showing a recycling state of liquid toner for the image forming apparatus of the first embodiment.

FIG. 3 is a partially enlarged diagram showing the state of FIG. 2.

FIG. 4 is a diagram showing another example of the first embodiment.

FIG. 5 is a diagram showing an example in which a replaceable, new carrier liquid cartridge is employed as a new carrier liquid supply tank.

FIG. 6 is a diagram showing the general configuration of an image forming apparatus according to the second embodiment of the present invention.

FIG. 7 is a diagram showing a recycling state of liquid toner for the image forming apparatus of the second embodiment.

FIG. 8 is a partially enlarged diagram showing the state of FIG. 7.

FIG. 9 is a diagram showing another example of the second embodiment.

FIG. 10 is a diagram showing an example in which, in addition to a collection of carrier liquid shown in FIG. 8, extra liquid toner is collected from an intermediate transfer member.

FIG. 11 is a diagram showing an example for a carrier liquid supply cartridge of the second embodiment.

FIG. 12 is a diagram showing another example for the carrier liquid supply cartridge.

FIGS. 13 and 14 are diagrams showing another example for the carrier liquid supply cartridge.

FIG. 15 is a diagram showing arrangement of an ultrasonic wave application unit of the second embodiment.

### DETAIL DESCRIPTION OF PREFERRED EMBODIMENTS

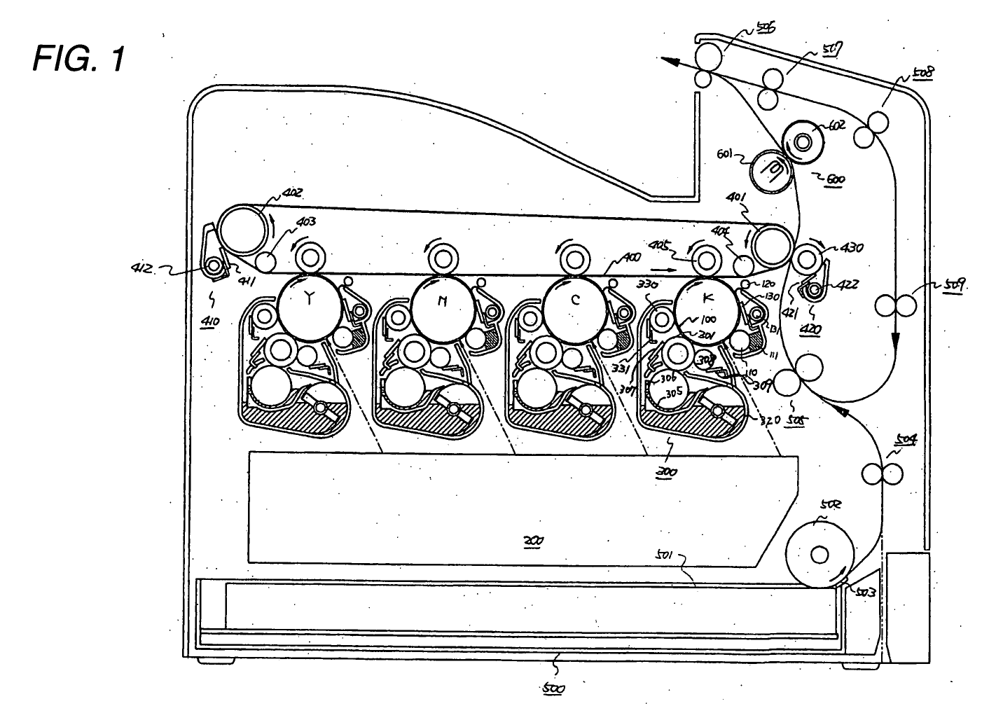

A first embodiment of the present invention will now be described while referring to the accompanying drawings. FIG. 1 is a diagram showing the general configuration of an image forming apparatus according to the embodiment of the present invention. As shown in FIG. 1, for the image forming apparatus of this embodiment, an intermediate transfer belt 400 is extended and fitted around a drive roller 401, a cleaner backup roller 402 and auxiliary rollers 403 and 404, and below the intermediate transfer belt 400, in a tandem arrangement, are positioned image forming units Y, M, C and K, for the colors yellow, magenta, cyan and black.

The image forming processing performed by the image forming apparatus of this embodiment will now be explained by employing the black image forming unit K. Since the yellow, magenta and cyan image forming units, Y, M and C, have the same arrangements, no further explanation for them will be given.

The surface of a photoreceptor 100, which is formed of an organic photosensitive material or an amorphous silicon photosensitive material, is charged uniformly by a charger 110, while a power supply device (not shown) applies a bias having the same polarity as the polarity of charged liquid toner.

Then, a laser scanning optical system 200, located below the individual image forming units, forms an electrostatic image for a black image on the photoreceptor 100, which has been uniformly charged.

A development device 300 includes a container 320 in which liquid toner is retained. In the container 320 is a toner supply roller 305 in which, on the surface, a fine uneven portion, such as a spiral groove, has been formed, and a toner regulation blade 306, which is a flexible metal plate on which urethane rubber has been deposited at its distal end. As the toner supply roller 305 is rotated, the toner regulation blade 306 is brought into contact with the toner supply roller 305, and scrapes the liquid toner using the uneven portion in the surface of the toner supply roller 305. Then, a development roller 301 in which a flexible material, such as a conductive urethan rubber, is formed on the surface of a metal core, is brought into contact with the toner supply roller 305. In this manner, liquid toner retained in the uneven portion on the surface of the toner supply roller 305 can be transferred to the surface of the development roller 301. Further, an equalization roller 308 is rotated while in contact with the development roller 301, and receives from the power source device (not shown) a bias having the same polarity as that of the charged liquid toner and that is higher than that of the development roller 301. In this state, the equalization roller 308 erases the fine uneven pattern from the surface of the toner supply roller 305 and equalizes the thickness of liquid toner. An equalization roller blade 309 contacts the equalization roller 308 in the direction opposite to the rotation, and scrapes liquid toner from the equalization roller 308. The liquid toner scraped off by the equalization roller blade 309 is returned to the reservoir of the container 320 by gravity. In the development device 300, a uniform liquid toner layer is formed on the development roller 301. Further, since the development roller 301, to which the development bias having the same polarity as the liquid toner has been applied by the power supply device (not shown), is rotated while in contact with the black image electrostatic latent image that is formed on the photoreceptor 100, the electrostatic latent image for a black image is visualized by the liquid toner.

The liquid toner used for this embodiment is such that solid particles having an average particle size of 1 μm, which have been obtained by dispersing a coloring agent, such as a pigment, in a thermoplastic resin, are dispersed at about a 20 weight % in a liquid solvent, such as an organic solvent, silicon oil, mineral oil or edible oil, while a dispersant is additionally provided.

Further, the development roller 301 may be formed of a flexible material, such as conductive urethane rubber, or a resin layer or a rubber layer around an outer wall of a metal core.

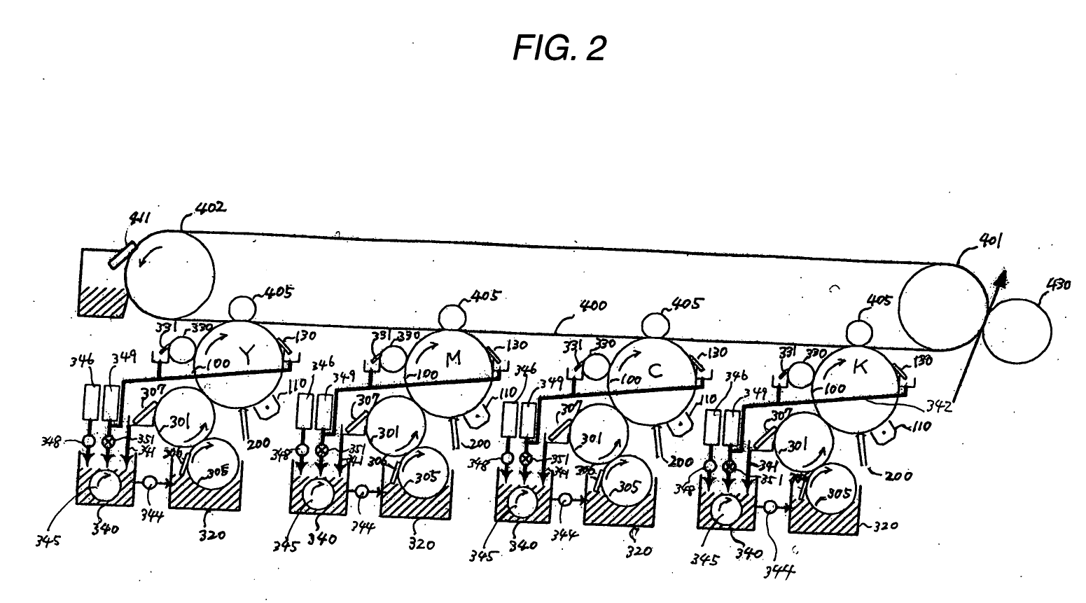

A development roller blade 307 is brought into contact with the surface of the development roller 301 downstream the development nip, and scrapes off the residual liquid toner to clean the surface of the development roller 301. The liquid toner scraped off by the development roller blade 307 is conveyed by gravity along a collection path 341 (see FIG. 2), and is collected in a liquid toner density adjustment tank 340 (see FIG. 2).

For a liquid toner image, immediately after being formed on the photoreceptor 100 by the development roller 301, the carrier liquid ratio is high, and image smearing will occur when a transfer device, which will be described later, performs the superimposition of colors on the intermediate transfer belt 400. Therefore, a bias having the same polarity as the charging characteristic of the toner is applied to a reduction roller 330, and as the reduction roller 330 is rotated in contact with the photoreceptor 100, an extra amount of carrier liquid is transferred in order to increase the ratio of the solid particles that are contained in the visible image. The carrier liquid transferred to the reduction roller 330 is scraped off by a reduction roller cleaner 331 and is conveyed downward along a collected carrier liquid conveying path 342 (see FIG. 2) by gravity, until finally it is collected in the liquid toner density adjustment tank 340 (see FIG. 2).

The appropriate reduction roller 330 is a flexible roller prepared by forming a flexible material, such as conductive urethane rubber, and a fluoroplastics face layer on the surface of a metal core.

Thereafter, a bias having a polarity that is the opposite of that of the charging characteristic of the liquid toner is applied by the power source device (not shown) to a primary transfer roller 405. Then, as the primary transfer roller 405 is rotated while in contact with the intermediate transfer belt 400, the visible image on the photoreceptor 100 is first transferred from the primary transfer roller 405 to the intermediate transfer belt 400. This image is superimposed on visible images for the other colors that have been formed, through the same image forming processing, upstream in the direction in which the intermediate transfer belt 400 is rotated. As a result, a full color image is obtained.

After the primary transfer has been completed, the electrostatic latent image is erased from the photoreceptor 100 by a neutralizing lamp 120, constituted by a rod light source, and the remaining liquid toner is removed by a photoreceptor cleaning blade 130 that contacts the photoreceptor 100.

The liquid toner that has been used and is scraped off by the photoreceptor 130 is conveyed downward along the collected carrier liquid conveying path 342 (see FIG. 2) by gravity, and is collected in the liquid toner density adjustment tank 340 (see FIG. 2).

The individual color visible images formed on the intermediate transfer belt 400 are conveyed to a secondary transfer section, which is constituted by the intermediate transfer belt 400, a drive roller 401 and a secondary transfer roller 430.

In consonance with the image forming progression timing, one of recording media 501, such as a sheet of paper, stacked in a paper cassette 500 is separated by a pickup roller 502 and a separation pad 503, and is fed to the secondary transfer section through a conveying roller pair 504 and a registration roller pair 505 that correct the skewed feeding and the feeding timing of a recording medium.

Through the employment of urging means (not shown), the secondary transfer roller 430 is pressed against the drive roller 401, via the intermediate transfer belt 400, and a full color image is secondarily transferred, from the intermediate transfer belt 400 to the recording medium 501, when a bias is applied, by the power source (not shown), for which the polarity is the opposite of that of the charging characteristic of the liquid toner.

A secondary transfer roller cleaner 420 is brought into contact with the secondary transfer roller 430, and a secondary transfer roller cleaning blade 421 scrapes from the surface of the secondary transfer roller 430 paper lint and liquid toner attached from the intermediate transfer belt 400. The paper lint and the liquid toner scraped off by the secondary transfer roller cleaning blade 421 are then conveyed, by a conveying screw 422, to the rear in FIG. 1, and are collected in a waste toner container (not shown).

After the secondary transfer has been completed, a belt cleaner 410 is brought into contact with the intermediate transfer belt 400 by a cleaner backup roller 402, and a belt cleaning blade 411 of the cleaner 410 scrapes off the secondary transfer toner and paper lint that remain on the surface of the intermediate transfer belt 400. The residual secondary transfer toner and the paper lint scraped off by the belt cleaning blade 411 are conveyed by a conveying screw 412 to the rear in FIG. 1, and are collected in the waste toner container (not shown).

The recording medium 501 bearing a full color image, which has been secondarily transferred, is passed through a fixing device 600 that includes a heat roller 601, provided with an internal heating means, and a pressure roller 602, the external surface of which is formed of a flexible material, such as a rubber. During this process, the full color image is fixed to the recording medium 501, under pressure, while the thermalplastics contained in the image are being melting. As a result, a desired image is obtained.

The recording medium 501, to which the image has been fixed, is discharged by a discharge roller pair 506 to the upper portion of the image forming apparatus. When image forming is to be performed for the reverse face of the same recording medium 501, the recording medium 501 is conveyed in a switchback manner by the discharge roller pair 506, which can be rotated in the reverse direction. Then, the recording medium 501 is again passed through refeed roller pairs 507, 508 and 509 and the registration roller 505, and an image is again transferred, by the second transfer section, to the reverse face of the recording medium 501, and is fixed by the fixing device 600. Thereafter, the resultant recording medium 501 is discharged by the discharge roller pair 506 to the upper portion of the image forming apparatus.

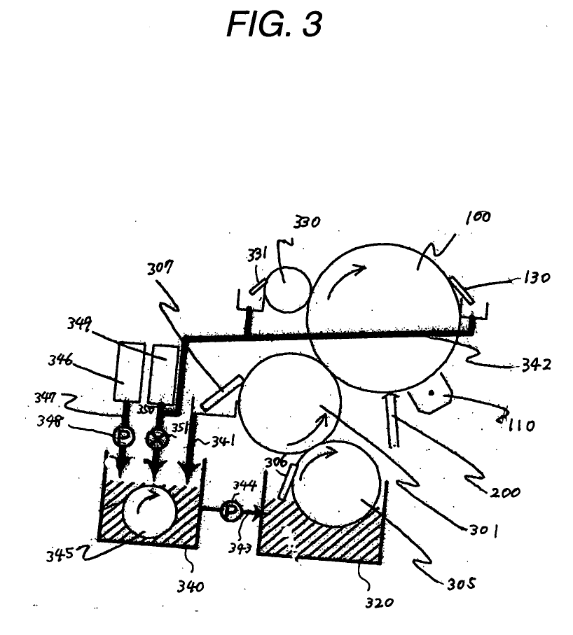

FIG. 2 is a diagram showing the recycling state of the liquid toner for the image forming apparatus of the present invention, and FIG. 3 is a partially enlarged diagram showing this state. The container 320 of the development device 300 in which the liquid toner is retained, communicates via a communication path 343 with the liquid toner density adjustment tank. A pump 344 is arranged along the communication path 343 in order to supply, to the liquid toner reservoir of the container 320, liquid toner, stored in the liquid toner density adjustment tank 340, that has been adjusted to obtain a predetermined density.

An agitation member 345 for agitating the carrier liquid and the toner is arranged in the liquid toner density adjustment tank 340. Further, a density detector (not shown) for detecting the density of the liquid toner is also arranged in the liquid toner density adjustment tank 340. Toner (having as a relative density: 25%) is supplied, from a toner tank 346, via a toner supply pipe 347. A pump 348 for supplying toner is located along the toner supply pipe 347, and since toner has high viscosity and low flowability, it is forcibly supplied by the pump 348.

The liquid toner that has been scraped off the surface of the development roller 301 by the development roller blade 307 is conveyed downward along the collection path 341 by gravity, and is collected in the liquid toner density adjustment tank 340. Further, the used liquid toner that has been scraped off the surface of the photoreceptor 100 by the photoreceptor cleaning blade 130 is conveyed downward along the collected carrier liquid conveying path 342 by gravity, and is collected in the liquid toner density adjustment tank 340.

Furthermore, the extra carrier liquid that has been transferred to the reduction roller 330, which is rotated while in contact with the photoreceptor 100, is scraped off by the reduction roller cleaner 331, conveyed downward along the collected carrier liquid conveying path 342 by gravity, and collected in the liquid toner density adjustment tank 340. Liquid that, following the secondary transfer, has been scraped off the intermediate transfer belt 400 by the belt cleaning blade 411 may be employed as the collected carrier liquid.

The collected carrier liquid conveying path 342 joins a new carrier liquid supply path 350, along which new carrier liquid from a new carrier liquid supply tank 349 is supplied downward by gravity. Since the viscosity of the collected carrier liquid and the new carrier liquid is low, these liquids can be carried downward by gravity, without a pump being required. And since the collected carrier liquid and the new carrier liquid are supplied together to the liquid density adjustment tank 340, the change in the density of the dispersant in the collected carrier liquid is moderated by the new carrier liquid, which does not contain a dispersant. Therefore, the characteristic of the liquid toner that is supplied from the liquid toner density adjustment tank 340 to the development device 300 is stabilized, and an image having a uniform quality is obtained.

Further, a flow rate adjustment valve 351 is arranged downstream of the juncture of the collected carrier liquid conveying path 342 and the new carrier liquid supply path 350. And when the amount of the supply of new carrier liquid is smaller than the amount of the collected carrier liquid (e.g., when full solid printing is continuously performed), the flow rate adjustment valve 351 is closed, and the new carrier liquid supply container 349 can be used as a buffer for temporarily retaining collected carrier liquid.

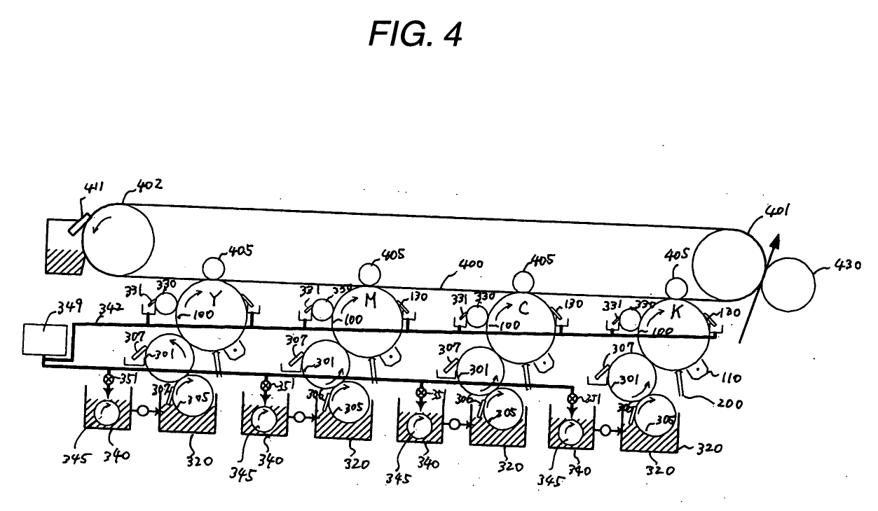

According to the embodiment of the invention shown in FIGS. 2 and 3, the collected carrier liquid conveying path 342 and the new carrier liquid supply tank 349 are provided for the individual image formation stations Y, M, C and K of the color image forming apparatus. However, as shown in FIG. 4, a collected carrier liquid conveying path 342 and a new carrier liquid supply tank 349 may be provided for use in common by the image forming stations Y, M, C and K of the color image forming apparatus.

A flexible tube, such as a taigon tube, can also be employed as a pipe for the collected carrier liquid conveying path 342. By employing a flexible pipe, the degree of freedom in the arrangement of devices is increased. And further, to facilitate flowability, the diameters of pipes may be changed in places.

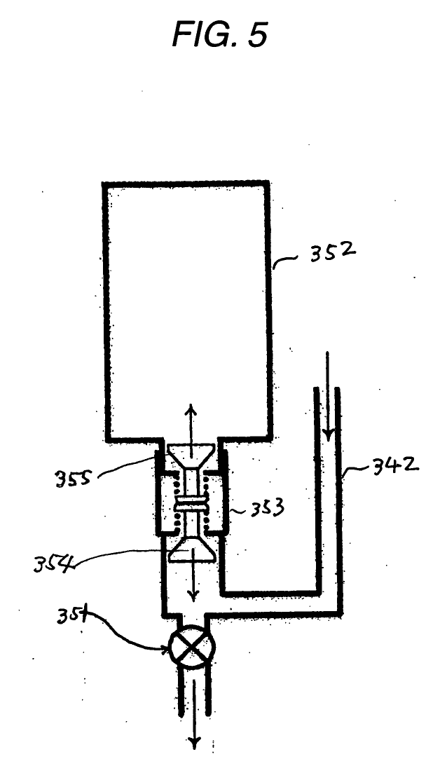

FIG. 5 is a diagram showing an example in which a replaceable, new carrier liquid cartridge 352 is employed as the new carrier liquid supply tank 349 (a toner tank is not shown). A bifurcated portion is formed in part of the collected carrier liquid conveying path 342, a junction 353 is formed along the collected carrier liquid conveying path 342, and a collected carrier liquid conveying path side backflow valve 354 is located at the junction 353. Further, a new carrier liquid cartridge side backflow valve 355 is located at the junction of the new carrier liquid cartridge 352. Since a replaceable cartridge is employed as the new carrier liquid supply tank 349, the exchange of a cartridge is easy for a user, and further, since the backflow valve is provided for both paths, the spilling of liquid during a cartridge exchange can be prevented.

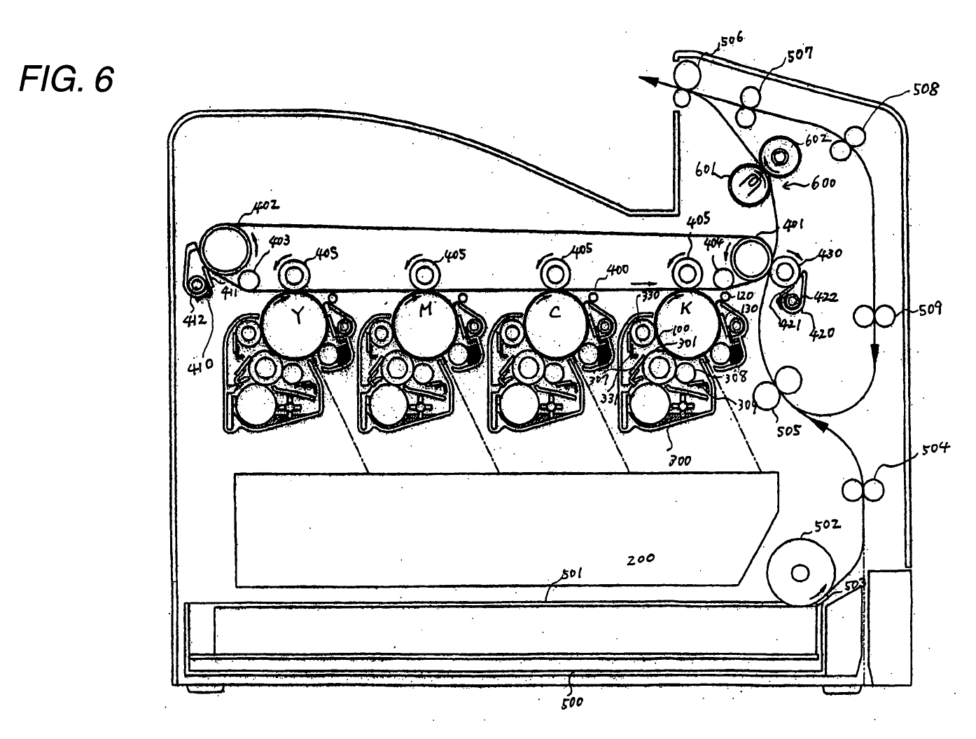

A second embodiment of the present invention will now be described while referring to the accompanying drawings (FIGS. 6 to 15). The components in the accompanying drawings are the same as the components having the same names in the first embodiment and have the same reference numerals, and description will be omitted.

A carrier liquid supply cartridge 849 is detachably connected along the collected carrier liquid conveying path 342. Since a collected carrier liquid and a new carrier liquid have a low viscosity, these liquids can be conveyed downward by gravity, without a pump being required.

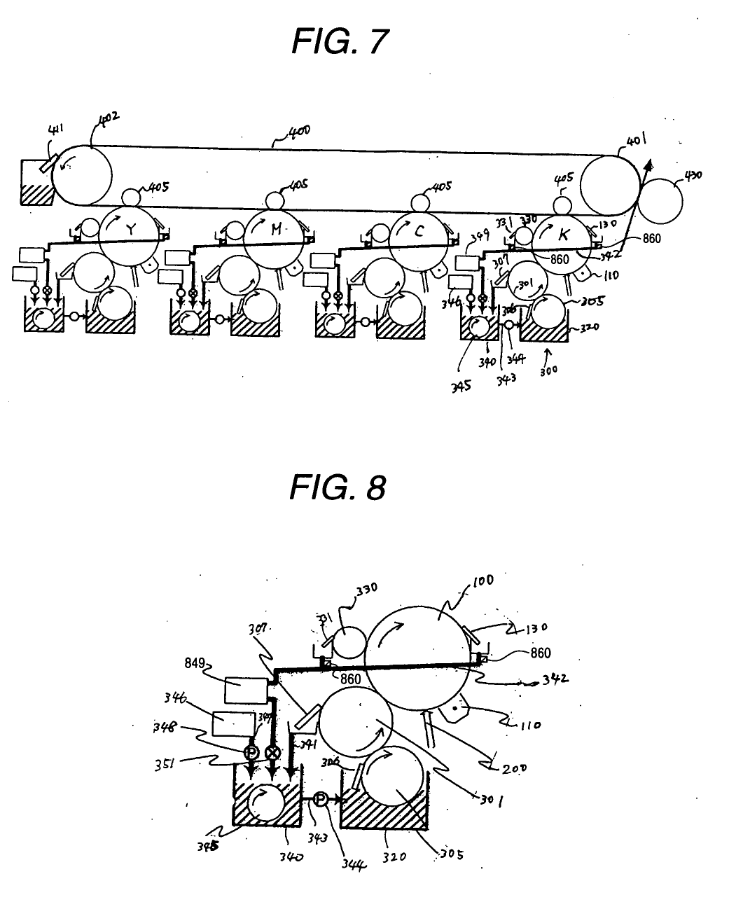

The flow rate adjustment valve 351 is arranged downstream of the connection of the carrier liquid supply cartridge 849 along the collected carrier liquid conveying path 342. And when the amount of the supply of new carrier liquid is smaller than the amount of the collected carrier liquid (e.g., when full solid printing is continuously performed), the flow rate adjustment valve 351 is closed, and the carrier liquid supply container 849 can be used as a buffer for temporarily retaining collected carrier liquid. It should be noted that the equalization roller 308 and the equalization roller blade 309 are not shown in FIGS. 7 and 8.

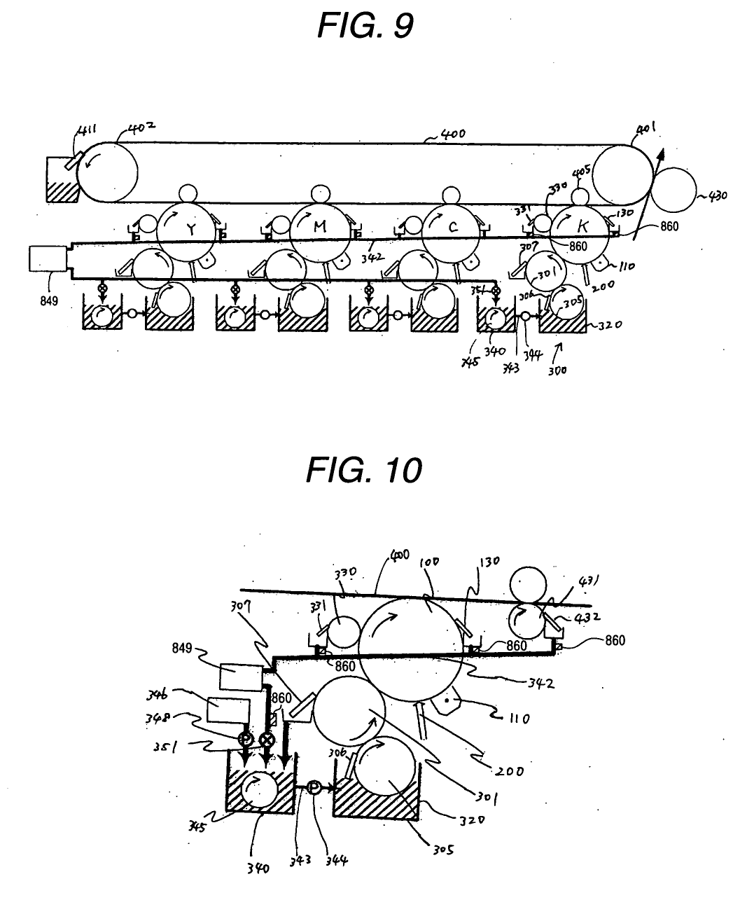

According to the embodiment of the invention shown in FIGS. 7 and 8, the collected carrier liquid conveying path 342 and the carrier liquid supply tank 849 are provided for the individual image formation stations Y, M, C and K of the color image forming apparatus. However, as shown in FIG. 9, a collected carrier liquid conveying path 342 and a carrier liquid supply tank 849 may be provided for use in common by the image forming stations Y, M, C and K of the color image forming apparatus. It should be noted that the equalization roller 308, the equalization roller blade 309 and the toner tank 346 are not shown in FIG. 9.

FIG. 10 is a diagram showing an example in which, in addition to the collection of carrier liquid shown in FIG. 8, extra liquid toner is collected from the intermediate transfer member 400. As shown in FIG. 10, extra liquid toner is transferred by bringing an intermediate transfer member squeeze roller 431 into contact with the intermediate transfer member 400, and the liquid toner is scraped off by an intermediate transfer member squeeze roller cleaner 432. The extra liquid toner that is scraped off in this manner is carried downward along the collected carrier liquid conveying path 342 by gravity, and is collected in the liquid toner density adjustment tank 340. It should be noted that the equalization roller 308 and the equalization roller blade 309 are not shown in FIG. 10.

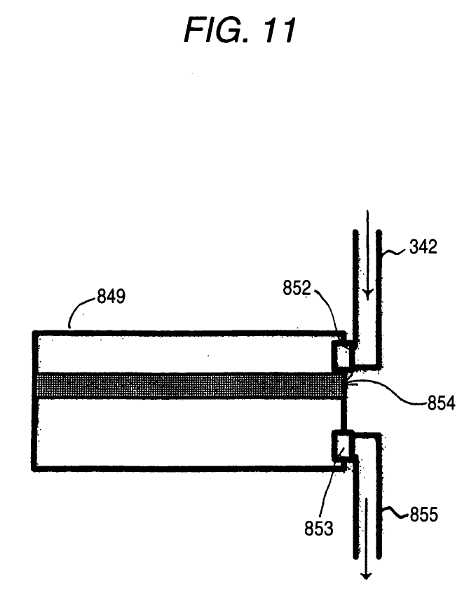

FIG. 11 is a diagram showing an example for the carrier liquid supply cartridge 849. The carrier liquid supply cartridge 849 includes: a collected carrier liquid entrance 852, connected to the collected carrier liquid conveying path 342; and a carrier liquid outlet 853, connected to a carrier liquid supply pipe 855, along which collected carrier liquid and new carrier liquid in the carrier liquid supply cartridge 849 are supplied to the liquid toner density adjustment tank 340. A filter 854 is located upstream of the carrier liquid outlet in the carrier liquid supply cartridge 849. And since toner particles contained in the collected carrier liquid can be caught by the filter 854, clogging of the pipes can be prevented.

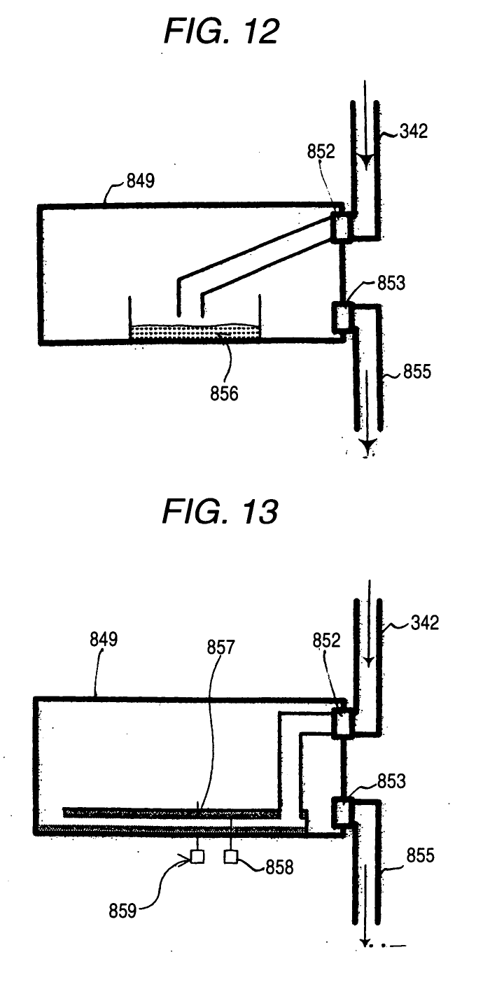

FIG. 12 is a diagram showing another example for the carrier liquid supply cartridge 849. The carrier liquid supply cartridge 849 includes: a collected carrier liquid supply entrance 852, connected to the collected carrier liquid conveying path 342; and a carrier liquid outlet 853, connected to a carrier liquid supply pipe 855, along which a collected carrier liquid and a new carrier liquid, in the carrier liquid supply cartridge 849, are supplied to the liquid toner density adjustment tank 340. A precipitation tank 856 is located upstream of the carrier liquid outlet in the carrier liquid supply cartridge 849. Since toner particles contained in the collected carrier liquid can be collected in the precipitation tank 856, clogging of the pipes can be prevented.

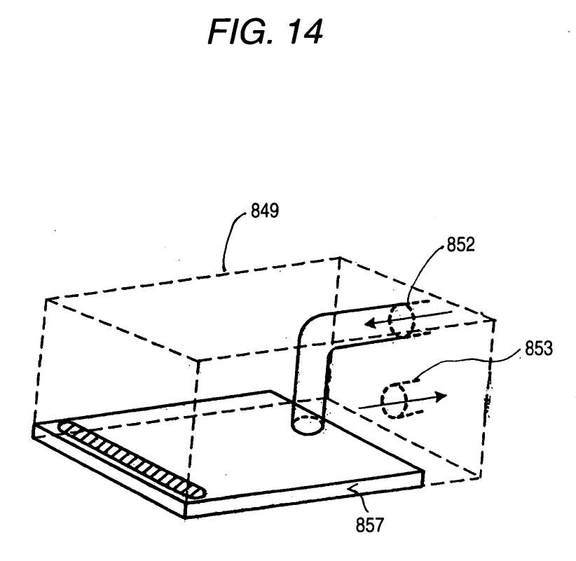

FIGS. 13 and 14 are diagrams showing an additional example for the carrier liquid supply cartridge 849. The carrier liquid supply cartridge 849 includes: a collected carrier liquid entrance 852, connected to the collected carrier liquid conveying path 342; and a carrier liquid outlet 853, connected to a carrier liquid supply pipe 855, along which a collected carrier liquid and a new carrier liquid in the carrier liquid supply cartridge 849 are supplied to the liquid toner density adjustment tank 340. An electrostatic precipitator 858 is located upstream of the carrier liquid outlet in the carrier liquid supply cartridge 849. With the electrostatic precipitator 857 in which a positive electrode 858 and a negative electrode 859 are arranged in parallel at a predetermined interval, toner particles in the collected carrier liquid that enter the space between the two electrodes 857 and 858 receive a positive charge. And thereafter, the positively charged toner particles are attracted to the negative electrode 859 and collected. Since toner particles contained in the collected carrier liquid can be collected by using the electrostatic precipitator 857, clogging of the pipes can be prevented.

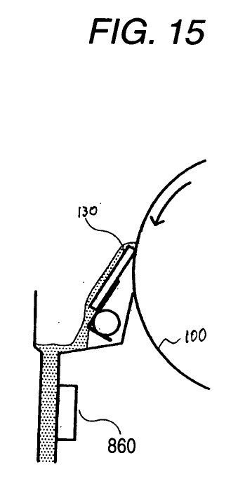

An ultrasonic wave application unit 860 is located at the junction of each of the photoreceptor cleaning blade 130 (see FIG. 15), the photoreceptor squeeze roller cleaner 331 and the intermediate transfer member squeeze roller cleaner 432 (see FIG. 10), which are collection sections of the liquid toner, and the collected carrier liquid conveying path 342. An ultrasonic wave application unit 860 is also arranged between the carrier liquid outlet of the carrier liquid supply cartridge 849 and the upstream located flow rate adjustment valve 351 (see FIG. 10). Through ultrasonic vibration applied by the ultrasonic wave application unit 860, the aggregation of toner particles in the collected liquid toner is prevented, flowability is increased, and the clogging of pipes is prevented.

What is claimed is:

1. An image forming apparatus, including a developing section in which an image is developed by using liquid toner, the image forming apparatus comprising:
a first path, in which the liquid toner having passed through the developing section is conveyed by gravity;
a tank, adapted to store a carrier liquid, and connected to a second path in which the carrier liquid stored in the tank is conveyed by gravity and which joins the first path.

2. The image forming apparatus according to claim 1, wherein a valve is arranged at a downstream side of a junction of the first path at which the second path joins the first path.

3. The image forming apparatus according to claim 1, wherein
the image forming apparatus has a plurality of the developing sections,
a plurality of the first path are provided with the developing sections, respectively, and
a plurality of the tank are provided with the developing sections, respectively.

4. The image forming apparatus according to claim 1, wherein
the image forming apparatus has a plurality of the developing sections,
the first path is provided with the developing sections in common, and
the tank is provided with the developing sections in common.

5. The image forming apparatus according to claim 1, wherein the tank includes a replaceable cartridge.

6. The image forming apparatus according to claim 5, wherein
a first backflow valve is provided at a replaceable cartridge side of a junction at which the second path joins the first path, and
a second backflow valve is provided at a first path side of the junction.

7. An image forming apparatus, including a developing section in which an image is developed by using liquid toner, the image forming apparatus comprising:
a first path, in which the liquid toner having passed through the developing section is conveyed by gravity;
a carrier liquid cartridge, adapted to store a carrier liquid, and provided with an inlet: which is detachably connected to the first path; and into which the liquid toner flows, and an outlet: from which the toner liquid and the carrier liquid flow out; and which is detachably connected to a second path in which the toner liquid and the carrier liquid are conveyed; and
a collector, located at an upstream side of the outlet in the carrier liquid cartridge, and operable to collect a toner particle.

8. The image forming apparatus according to claim 7, wherein a valve is arranged at a downstream side of the outlet.

9. The image forming apparatus according to claim 7, wherein the collector includes a filter.

10. The image forming apparatus according to claim 7, wherein the collector includes a precipitation tank.

11. The image forming apparatus according to claim 7, wherein the collector includes an electrostatic precipitator.

12. The image forming apparatus according to claim 7, wherein
the image forming apparatus has a plurality of the developing sections,
a plurality of the first path are provided with the developing sections, respectively, and
a plurality of the carrier liquid cartridge are provided with the developing sections, respectively.

13. The image forming apparatus according to claim 7, wherein
the image forming apparatus has a plurality of the developing sections,
the first path is provided with the developing sections in common, and
the carrier liquid cartridge is provided with the developing sections in common.

14. An image forming apparatus, including a developing section in which an image is developed by using liquid toner, the image forming apparatus comprising:
a first path, in which the liquid toner having passed through the developing section and collected at a collection section is conveyed by gravity;
a carrier liquid cartridge, adapted to store a carrier liquid, and connected to the first path;
an ultrasonic wave application unit, located at a connection part connecting the first path and the collection section, and operable to apply ultrasonic vibration to a toner particle.

15. The image forming apparatus according to claim 14, wherein the collection section is one of either a photoreceptor squeeze roller, for collecting extra carrier liquid from a photoreceptor, an intermediate transfer member squeeze roller, for collecting extra carrier liquid from an intermediate transfer member, and a photoreceptor cleaner blade, or an assembly that includes all of these.

16. The image forming apparatus according to claim 14, wherein a valve is located at a downstream side of an outlet of the carrier liquid cartridge from which the toner liquid and the carrier liquid flow out.

17. The image forming apparatus according to claim 16, wherein an ultrasonic wave application unit is arranged between the outlet and the valve.

18. The image forming apparatus according to claim 14, wherein
the image forming apparatus has a plurality of the developing sections,
a plurality of the first path are provided with the developing sections, respectively, and
a plurality of the carrier liquid cartridge are provided with the developing sections, respectively.

19. The image forming apparatus according to claim 14, wherein
the image forming apparatus has a plurality of the developing sections,
the first path is provided with the developing sections in common, and
the carrier liquid cartridge is provided with the developing sections in common.
